(19) United States
(12) Patent Application Publication
(10) Pub. No.: US 2004/0088847 A1
(43) Pub. Date: May 13, 2004

(54) Wire rope socket

(75) Inventor: Daryl R. Sugden, Innisfail (CA)

Correspondence Address: BAKER BOTTS, LLP, 910 LOUISIANA, HOUSTON, TX, 77002-4995, US

(73) Assignee: Nabors Industries, Inc., Houston, TX

(21) Appl. No.: 10/688,643

(22) Filed: Oct. 17, 2003

(30) Foreign Application Priority Data
Nov. 8, 2002 (CA) 2,411,619

(51) Int. Cl. B23Q 17/00

(52) U.S. Cl. 29/407.05; 29/461; 29/527.4; 29/530

(57) ABSTRACT

A wire rope and socket combination comprises a wire rope socket, a rope formed of strands of twisted wires extending into the wire rope socket, selected strands of the twisted wires being bent over 180 degrees within the wire rope socket to provide a selected breaking strength; and babbit securing the rope in the wire rope socket. A method of constructing a wire rope socket, the method comprising the steps of: bending selected strands of a rope formed of twisted wires over 180 degrees to form bent strands; inserting the rope and bended strands into a wire rope socket; and pouring molten babbitt into the wire rope socket to secure the rope in the wire rope socket.

### BACKGROUND OF THE INVENTION

This invention relates to equipment and methods used for the suspension of weights on wire ropes, particularly as used in the swabbing of oil and gas wells.

Swabbing tools and other downhole equipment are often lowered into wells using wire ropes. The wire ropes require termination so that equipment can be attached to their downhole ends. A known way of doing this is to use a socket. The free end of the wire rope is inserted into a socket, and the strands making up the wire rope are bent over 180° before the wire rope is pulled back into the socket. The strands may be bent to the outside or the inside of the wire rope. Once the bent over strands are pulled back into the socket, the socket is filled with molten metal (babbitt). This technique can increase the strength of the wire rope socket to close to the breaking strength of the wire rope, particularly using the strands bent over towards the inside of the wire rope. While this method provides a strong connection of the wire rope to the socket and therefore to a downhole tool, it does not provide variable strength wire rope sockets. The present invention is intended to overcome this problem.

### SUMMARY OF THE INVENTION

There is therefore provided a wire rope and socket combination with breaking strength that can be pre-selected. According to an aspect of the invention, a wire rope and socket combination comprises a wire rope socket and a rope formed of strands of twisted wires extending into the wire rope socket. One or more but not all of strands of the twisted wires are bent over 180 degrees within the wire rope socket to provide a selected breaking strength of the wire rope socket. Babbit secures the rope in the wire rope socket. The strands are bent in the direction in which an interior bore of the wire rope socket narrows.

According to a further aspect of the invention, there is provided a method of constructing a wire rope socket. The method comprises bending one or more but not all of the strands of a rope formed of strands of twisted wires over 180 degrees to form bent strands; inserting the rope and bent strands into a wire rope socket; and pouring molten babbitt into the wire rope socket to secure the rope in the wire rope socket.

According to a further aspect of the invention, there is provided a method of constructing wire rope sockets of variable breaking strength, the method comprising the steps of building several wire rope sockets having different numbers of strands bent over 180° and pulled back into the wire rope socket, testing the breaking strength of the several wire rope sockets to obtain a relationship between number of strands bent and breaking strength of the wire rope socket; and selecting the number of bent strands in a wire rope socket according to a desired breaking strength of the wire rope socket.

These and other aspects of the invention are described in the detailed description of the invention and claimed in the claims that follow.

### BRIEF DESCRIPTION OF THE DRAWINGS

There will now be described preferred embodiments of the invention, with reference to the drawings, by way of illustration only and not with the intention of limiting the scope of the invention, in which like numerals denote like elements and in which:

FIG. 1 shows a wire rope with straight strands emerging from the socket;

FIG. 2 shows a wire rope with selected strands bent; and

FIG. 3 shows the bent strands retracted into the socket.

### DETAILED DESCRIPTION OF PREFERRED EMBODIMENTS

In this patent document, “comprising” means “including”. In addition, a reference to an element by the indefinite article “a” does not exclude the possibility that more than one of the element is present. The breaking strength of a wire rope socket is determined by the force required for the wire rope socket to fail, and the wire rope to pull out from the wire rope socket, under stresses applied along the length of the wire rope and wire rope combination.

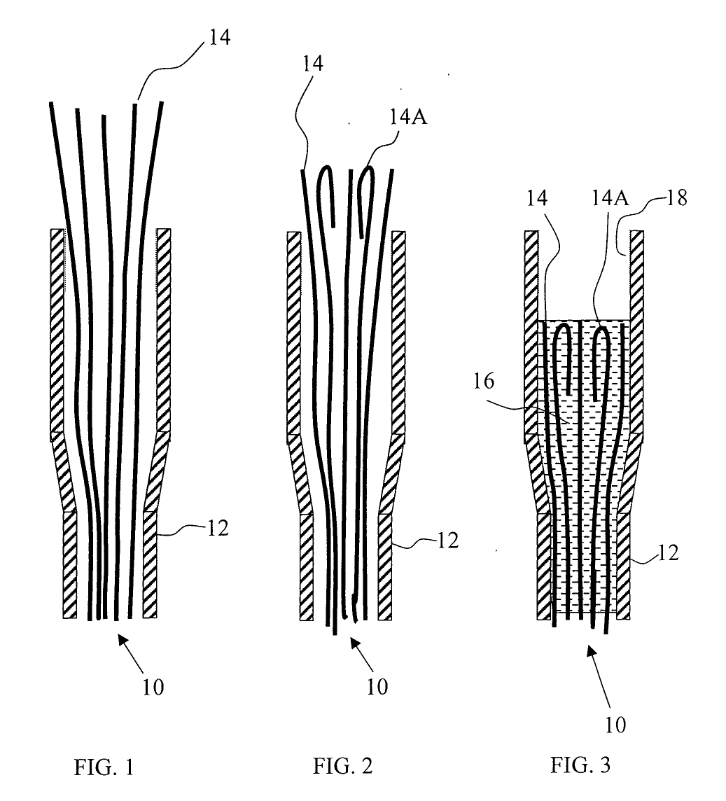

In FIG. 1, a wire rope 10 is shown extending through a socket 12 and terminating in strands 14 of twisted wires. In FIG. 2, selected strands 14A are bent over 180°. In FIG. 3, the wire rope including straight strands 14 and bent strands 14A are pulled back into the socket 12. Each socket 12 conventionally is internally threaded at its wide end 18 for attachment to swabbing tools. The wire rope and bent strands 14A are pulled far enough into the socket 12 to allow access to the internal threading, as shown in FIG. 3. The socket 12 has an interior bore that is tapered, and the strands are bent back in the direction of narrowing of the taper. Babbitt 16 is poured into the socket to secure the wire rope 10 in the socket 12 and allowed to solidify in conventional manner. One or more but not all of the strands 14 of the wire rope 10 are bent over. The remaining strands 14 are cut to a suitable length for fitting into the socket 12 on pulling back of the wire rope 10. The babbitt 16 is poured into as much of the socket 12 as possible, while leaving the threaded end 18 of the socket 12 available for use. A vent hole (not shown) may be used as an overflow below the threaded portion of the socket so that the socket will not be overfilled with babbitt.

Given a particular size and design of a wire rope and socket combination, the number of strands bent over determines the breaking strength of the wire rope and socket combination. For example, with a 9/16 inch wire rope formed of 6 strands, each strand being formed of 7 twisted wires, bending over no strands results in a breaking strength of about 3000 lbs, while bending over two strands results in a breaking strength of about 8000-10,000 lbs, and bending over three strands results in a breaking strength of about 13,000 lbs. Bending over all of the strands results in a breaking strength of about 23,000 lbs.

Conventional precautions should be taken in making the wire rope socket. For example, the babbitt should be pure and the wire rope clean. The length of strand bent over should also be sufficient to affect the breaking strength, as for example 0.5 inches to 2 inches of strand. The babbitt should cover an adequate amount of the wire rope in the socket, and the wire rope socket should be heated before the babbitt is poured into the socket to ensure the babbitt stays molten and engulfs the wire rope before hardening. Voids in the babbitt should be avoided.

For any given wire rope, several wire rope sockets may be built having different numbers of selected strands bent. The breaking strength of the wire rope sockets may then be tested to obtain a relationship between number of strands bent and breaking strength. Thereafter, the number of bent strands in a wire rope socket may be selected, using the relationship thus defined, according to a desired breaking strength of the wire rope socket. In the example given above, if a wire rope is desired to have a breaking strength of 9000 lbs, then a wire rope with two bent over stands would be selected. Such a situation may arise for example where it is desired to be able to pull the wire rope from a well after the downhole equipment to which it is attached has become stuck downhole.

Immaterial modifications may be made to the invention described here without departing from the essence of the invention.

What is claimed is:

1. A wire rope and socket combination; comprising
a wire rope socket;
a rope formed of strands of twisted wires extending into the wire rope socket;
one or more but not all of the strands of the twisted wires being bent over 180 degrees within the wire rope socket to provide a selected breaking strength of the wire rope socket; and
babbit securing the rope in the wire rope socket.

2. The wire rope and socket combination of claim 1 in which the wire rope socket has a tapered bore, and the bent strands are bent in the direction of narrowing of the tapered bore.

3. A method of constructing a wire rope socket, the method comprising the steps of:
bending one or more but not all of the strands of a rope formed of strands of twisted wires over 180 degrees to form bent strands;
inserting the rope and bent strands into a wire rope socket; and
pouring molten babbit into the wire rope socket to secure the rope in the wire rope socket.

4. The method of claim 3 in which the wire rope socket has a tapered bore, and the bent strands are bent in the direction of narrowing of the tapered bore.

5. A method of constructing wire rope sockets of variable breaking strength, the method comprising the steps of:
repeating the method steps of claim 3 to build several wire rope sockets having different numbers of bent strands;
testing the breaking strength of the several wire rope sockets to obtain a relationship between number of bent strands and breaking strength of the wire rope socket; and
selecting the number of bent strands in a wire rope socket according to a desired breaking strength of the wire rope socket.
